(19) United States
(12) Patent Application Publication
(10) Pub. No.: US 2003/0039320 A1
(43) Pub. Date: Feb. 27, 2003

(54) Device and method for determining the respectively present level of a digital signal

(76) Inventors: Axel Christoph, Telfs (AT); Viktor Kahr, Hart Bei Graz (AT); Axel Reithofer, Graz (AT); Harald Panhofer, Graz (AT)

Correspondence Address: LERNER AND GREENBERG P.A., Post Office Box 2480, Hollywood, FL, 33022-2480, US

(21) Appl. No.: 10/139,973

(22) Filed: May 7, 2002

(30) Foreign Application Priority Data
May 7, 2001 (DE) 101 22 023.5

(51) Int. Cl. H04L 25/06

(52) U.S. Cl. 375/317; 327/72

(57) ABSTRACT

The device and the method enable determining a respectively current level of a digital signal. The digital signal is compared with a threshold value that is located between the state representing the low level of the digital signal and the state representing the high level of the digital signal. The threshold value that is used is matched to the prevailing conditions, that is, the threshold value is defined taking account of the waveform of the digital signal.

### BACKGROUND OF THE INVENTION

Field of the Invention

The present invention relates to an apparatus for determining the level of a digital signal and to a corresponding method. More specifically, the invention relates to a device for determining the respectively present level of a digital signal,

having a comparison device which compares the digital signal with a threshold value which is located between the state which represents the low level of the digital signal and the state which represents the high level of the digital signal, and

having a threshold value determining device, which defines the threshold value which is used, and to

a method for determining the respectively present level of a digital signal,

wherein the digital signal is compared with a threshold value which is located between the state which represents the low level of the digital signal and the state which represents the high level of the digital signal, and

wherein a threshold value which is matched to the prevailing conditions is used.

Devices and methods such as these are required, in particular in order to determine respectively present levels of a digital signal for which the signal state which represents the low level and/or the signal state which represents the high level are not known, or are not known accurately, and/or can change.

Digital signals for which this is the case are, for example, the output signals from Hall sensors which are used as active rotation speed sensors. Manufacturing tolerances or temperature dependences are responsible, by way of example, for said uncertainties.

The respectively present level of a digital signal is normally determined using a threshold value, which is located between the state which represents the high level of the digital signal and the state which represents the low level of the digital signal. The respectively present level of the digital signal can then easily be determined by comparing the digital signal with the threshold value; in this case, it is assumed that the digital signal is at the high level when and for as long as the digital signal is greater than the threshold value, and that the digital signal is at the low level when and for as long as the digital signal is below the threshold value (or vice versa).

If attempts were made to determine the respectively present level of a digital signal of which the signal state which represents the low level and/or the signal state which represents the high level are/is not known or are not accurately known and/or can change, using a fixed threshold value setting, then this would result in a high probability of the chosen threshold value not being optimum or, to be more precise, being closer (too close) to the state which represents the high level of the digital signal or being closer (too close) to the state which represents the low level of the digital signal.

This is illustrated, by way of example, in FIGS. 6A, 6B and 6C.

FIGS. 6A to 6C show the current waveforms of digital signals DS emitted from a Hall sensor at different times, or digital signals DS emitted from different Hall sensors of the same type.

In the case of the digital signal shown in FIG. 6A, the current which represents the low level of the digital signal DS is a current Il1, and the current which represents the high level of the digital signal DS is a current Ih1; in the case of the digital signal which is shown in FIG. 6B, the current which represents the low level of the digital signal DS is a current Il2, and the current which represents the high level of the digital signal DS is a current Ih2; in the case of the digital signal which is shown in FIG. 6C, the current which represents the low level of the digital signal DS is a current Il3, and the current which represents the high level of the digital signal DS is a current Ih3. As can be seen from the figures, both the currents Il1, Il2 and Il3 which represent the low levels of the digital signals and the currents Ih1, Ih2 and Ih3 which represent the high levels of the digital signals are of different magnitude.

If one wished to determine the respectively present levels of the digital signals using a constant threshold value, to be more precise using a constant threshold current Is, then this would lead to an optimum result in the case shown in FIG. 6A. In this case, the threshold current Is is located precisely in the center between Il1 and Ih1, further correct determination of the respectively present level of the digital signal is possible even when the digital signal DS has disturbances superimposed on it.

In the case shown in FIG. 6B, the threshold value Is is very much closer to Il2 than to Ih2. This means that, when the digital signal DS has disturbances superimposed on it, a current which represents a low level of the digital signal may exceed the threshold current Is, and could thus be interpreted as a high level of the digital signal.

A corresponding situation applies to the case illustrated in FIG. 6C. In the case shown in FIG. 6C, the threshold current Is is very much closer to Ih3 than to Il3. This means that, when disturbances are superimposed on the digital signal DS, a current which represents a high level of the digital signal may be below the threshold value Is, and could thus be interpreted as a low level of the digital signal.

For the reasons mentioned, it has been found to be advantageous for the threshold value which is used to be dynamically matched to the respectively prevailing conditions.

This may be done, for example, by determining the maximum current and the minimum current of the digital signal, and by placing the threshold current at a specific point, for example in the center between these extreme values. However, this is not free of disadvantages, either. In particular, the threshold current defined in this way may be severely influenced by disturbances superimposed on the digital signal, and may still be well away from the optimum threshold value.

A further option for dynamic definition of the threshold value is to subject the digital signal to low-pass filtering and to use the signal obtained in this way as the threshold value. This has the disadvantage that this type of threshold value definition is suitable only for digital signals with a duty ratio of 50%; for other duty ratios, the result of the low-pass filtering does not represent the mean value between the current which represents the high level and the current which represents the low level, so that it is not suitable for use as a threshold value or for determining the threshold value.

### SUMMARY OF THE INVENTION

It is accordingly an object of the invention to provide a device and a method for determining a level of a digital signal, which overcomes the above-mentioned disadvantages of the heretofore-known devices and methods of this general type and which enables the level of a digital signal to be identified reliably, without any error, even when the signal state which represents the low level and/or the signal state which represents the high level are/is not known or are/is not known accurately, and/or may change.

With the foregoing and other objects in view there is provided, in accordance with the invention, a device for determining a respectively present level of a digital signal, comprising:

a comparison device configured to compare the digital signal with a threshold value defined between a state representing a low level of the digital signal and a state representing a high level of the digital signal; and

a threshold value determining device connected to said comparison device for defining the threshold value to be used by said comparison device and thereby taking into account a waveform of the digital signal.

In other words, the device according to the invention is distinguished in that the threshold value determining device defines the threshold value taking account of the waveform of the digital signal.

With the above and other objects in view there is also provided, in accordance with the invention, a method for determining the respectively present level of a digital signal. The method comprises the following steps:

comparing the digital signal with a threshold value which defined between a state representing a low level of the digital signal and a state representing a high level of the digital signal; and

matching the threshold value to prevailing conditions and defining the threshold value taking account of a waveform of the digital signal.

In other words, the method according to the invention is distinguished in that the threshold value is defined taking into account the waveform of the digital signal.

It is thus possible, for example, to determine the state which represents the low level of the digital signal and/or the state which represents the high level of the digital signal, and to define the threshold value taking account of the result of this determination process.

This in turn allows the threshold value to be defined such that it always assumes a predetermined relative position with respect to the state which represents the high level of the digital signal and/or with respect to the state which represents the low level of the digital signal.

The state which represents the low level of the digital signal and/or the state which represents the high level of the digital signal can be determined, for example, by means of a low-pass filter which is used according to claims 5 to 16 and 22 to 33, and does not result in any technical difficulties.

Furthermore, an option which can be implemented easily has been found for defining the threshold value such that the level of a digital signal can be identified reliably and without errors even when the signal state which represents the low level and/or the signal state which represents the high level are/is not known or are/is not known accurately and/or can change.

Other features which are considered as characteristic for the invention are set forth in the appended claims.

Although the invention is illustrated and described herein as embodied in an device and method for determining the respectively present level of a digital signal, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic block diagram of a first exemplary embodiment of a novel device according to the invention for determining the respectively present level of a digital signal;

FIG. 2 is a schematic block diagram of a second exemplary embodiment of a novel device for determining the respectively present level of a digital signal;

FIG. 3 is a schematic block diagram of a third exemplary embodiment of a novel device for determining the respectively present level of a digital signal;

FIG. 4 are three timing charts to illustrate the position of the reference currents used in the device shown in FIG. 3;

FIG. 5 is a diagram showing how the output signal is determined from a logic device L contained in the device shown in FIG. 3; and

FIG. 6 are three timing charts illustrating the problems which can occur in a conventional prior art device for determining the respectively present level of a digital signal.

### DESCRIPTION OF THE PREFERRED EMBODIMENTS

The arrangements and methods described in the following text are part of a motor vehicle controller and are used to determine the respectively present level of a signal which is emitted from a Hall sensor that is used as an active rotation speed sensor. However, it should be mentioned at this point that the arrangements and methods described in the following text also allow the respectively present levels of any other desired digital signals to be determined, of which the state which represents the low level and/or the state which represents the high level are/is not known or not known accurately, and/or may change. The described arrangements and methods also need not be part of a motor vehicle controller.

The digital signals whose respectively present level is determined by means of the arrangements and methods described in the following text, are signals for which different levels are represented by currents of different magnitude. However, the respectively present levels of digital signals for which different levels appear as voltages of different magnitudes may also be determined in precisely the same way.

In the example under consideration, the current which represents the high level of the digital signal to be converted is greater by a specific factor than the current which represents the low level. This factor does not depend, or at most depends to an insignificant extent, on the magnitude of the current which represents the low level or the current which represents the high level and, in the example under consideration, has the value 2; in principle, however, the factor could also be very much greater or smaller, without any restriction. In the same way, the described arrangements and methods may also be used after appropriate modification, of course, in the situation where the current which represents the high level in the digital signal is smaller than the current which represents the low level.

The described arrangements and methods result in the digital signal to be converted being converted to a second digital signal whose current and/or voltage waveform correspond/corresponds to the level waveform of the signal to be converted, and for which the current which represents the low level, or the voltage which represents the low level, and the current which represents the high level, or the voltage which represents the high level, have defined values, which do not fluctuate.

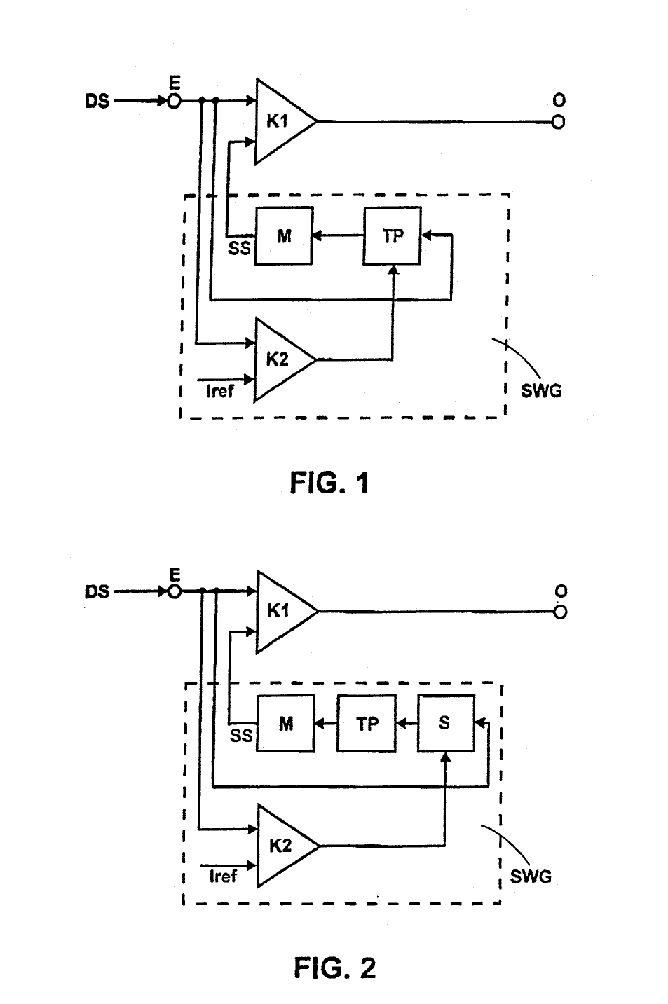

A first exemplary embodiment of an arrangement for determining the respectively present level of a digital signal is illustrated in FIG. 1.

The arrangement which is shown in FIG. 1 has an input connection E, an output connection 0, a comparator K1 and a threshold value determining device SWG, with the threshold value determining device SWG containing a second comparator K2, a low-pass filter TP and a multiplexer M.

The digital signal whose respectively present level is intended to be determined by the illustrated arrangement is annotated by the reference symbol DS and is input into the input connection E of the arrangement. The arrangement converts this digital signal DS to a digital signal whose current and/or voltage waveform corresponds to the level waveform of the signal to be converted, and for which the current which represents the low level, or the voltage which represents the low level, and the current which represents the high level, or the voltage which represents the high level, have defined values which do not fluctuate.

The digital signal corresponds, for example, to one of the digital signals DS shown in FIGS. 6A, 6B or 6C.

The digital signal DS is supplied to a first input connection of the first comparator K1. The second input connection of the first comparator K1 is supplied with a threshold current SS, which is produced by the threshold value determining device SWG.

The first comparator K1 compares the currents DS and SS supplied to it and emits a signal which represents a high level (a current which represents a high level or a voltage which represents a high level) when the present value of the digital signal DS is greater than the threshold current SS, and emits a signal which represents a low level (a current which represents a low level or a voltage which represents a low level) when the present value of the digital signal DS is less than the threshold current SS (or vice versa).

The threshold current SS which is produced by the threshold value determining device SWG is designed, in the example under consideration, such that it is located precisely in the center between the current which represents the low level in the digital signal DS and the current which represents the high level in the digital signal.

This means:

that the threshold value determining device SWG determines the current which represents the low level in the digital signal DS and/or the current which represents the high level in the digital signal, and

that the threshold current SS which is to be determined by the threshold value determining device SWG is defined as a function of the result of this determination process,

wherein that part of the threshold value determining device which determines the signal state which represents the low level is deactivated when and for as long as the digital signal is in a state which represents the high level, and/or

wherein that part of the threshold value determining device which determines the signal state which represents the high level is deactivated when and for as long as the digital signal is in a state which represents the low level.

That part of the threshold value determining device SWG which determines the current which represents the low level in the digital signal DS and/or the current which represents the high level in the digital signal DS is the low-pass filter TP in the example under consideration.

The low-pass filter TP subjects the digital signal DS, to be more precise parts of it which represent a low level, to low-pass filtering.

The fact that only those parts of the digital signal DS which represent the low levels are subjected to low-pass filtering means that the low-pass filter TP is activated by the output signal from the second comparator K2 when and for as long as the digital signal has a current which represents a low level, and that the low-pass filter TP is deactivated by the output signal from the second comparator K2 when and for as long as the digital signal has a current which represents a high level.

The second comparator K2 compares the digital signal DS with a reference current Iref which, for example, corresponds to the threshold current Is according to FIGS. 6A, 6B and 6C. The second comparator K2 emits a signal which activates the low-pass filter TP when and for as long as DS is less than Iref, and emits a signal which deactivates the low-pass filter TP when and for as long as DS is greater than Iref.

The signal which is emitted from the low-pass filter TP corresponds to the direct-current component of those parts of the digital signal which are subjected to low-pass filtering, that is to say to the current which represents the low level.

This signal is multiplied by the multiplier M. The factor by which it is multiplied has the value 1.5 in the example under consideration.

Since, in the example under consideration, the current which represents the high level is approximately twice as great as the current which represents the low level, the current produced by the multiplication is located precisely in the center between the current which represents the low level and the current which represents the high level. The current produced by the multiplication is used as the threshold current SS, and is supplied to the second input connection of the first comparator K1.

Threshold value production in such a way means that relatively small fluctuations in the current which represents the low level in the digital signal and/or in the current which represents the high level in the digital signal cannot lead to incorrect determination of the respectively present level of the digital signal DS. In the worst case, such fluctuations result in the threshold value no longer being located precisely in the center between the current which represents the low level and the current which represents the high level, with this shift in the threshold value generally being very small, and tending to zero again once the disturbance which caused the shift has decayed.

Clearly, the factor by which the multiplier multiplies the current supplied to it need not have the value (1.5) used in the example under consideration. The magnitude of this value depends on the specific case, to be more precise on the ratio between the current which represents the low level and the current which represents the high level, and on the desired position of the threshold value with respect to the current which represents the low level in the digital signal and the current which represents the high level in the digital signal.

Furthermore, it is clear that the same result will be obtained (for the same threshold value) if those parts of the digital signal DS which represent the high level are subjected to low-pass filtering, that is to say if the low-pass filter TP is activated by the output signal from the second comparator K2 when and for as long as the digital signal has a current which represents a high level, and the low-pass filter is deactivated by the output signal from the second comparator K2 when and for as long as the digital signal has a current which represents a low level, and when the signal which results from this low-pass filtering is multiplied by a different factor (being multiplied by 0.75 in the example under consideration).

The low-pass filter TP must be a low-pass filter which can be stopped by the output signal from the second comparator K2. A low-pass filter wherein this is possible is, for example, a low-pass filter in the form of a digital filter.

FIG. 2 shows a second exemplary embodiment of an arrangement for determining the respectively present level of the digital signal.

The arrangement which is shown in FIG. 2 corresponds largely to the arrangement which is shown in FIG. 1. Components which are identified by the same reference symbols are identical or mutually corresponding components.

The arrangement which is shown in FIG. 2 differs from the arrangement which is shown in FIG. 1 in the threshold value determining device SWG, to be more precise in the way wherein only the current which represents the low level in the digital signal DS is subjected to low-pass filtering. In the arrangement which is shown in FIG. 1, this is done by the low-pass filter TP being controlled appropriately (being activated and deactivated) by the output signal from the second comparator K2. In the arrangement which is shown in FIG. 2, this is done by the output signal from the second comparator K2 controlling a switching device S which is arranged between the input connection E of the arrangement and the low-pass filter TP.

The output signal from the second comparator K2 switches the switching device S to a first state when and for as long as the digital signal DS has a current which represents a low level, and the output signal from the second comparator K2 switches it to a second state when and for as long as the digital signal DS has a current which represents a high level.

The second comparator K2 compares the digital signal DS with a reference current Iref which, by way of example, corresponds to the threshold current Is shown in FIGS. 6A, 6B and 6C. The second comparator K2 emits a signal which switches the switching device to the first state when and for as long as DS is less than Iref, and emits a signal which switches the switching device to the second state when and for as long as DS is greater than Iref.

When and for as long as the switching device S is switched to the first state, it emits to the low-pass filter TP the signal DS supplied to it or a signal which corresponds to this signal; when and for as long as the switching device S is switched to the second state, it emits to the low-pass filter TP only half the current supplied to it.

The low-pass filter TP is thus at all times supplied with the current which represents the low level of the digital signal.

The signal which is emitted from the low-pass filter TP thus, as in the case of the arrangement shown in FIG. 1, corresponds to the direct-current component of the current which represents the low level of the digital signal.

The arrangement shown in FIG. 2 results in precisely the same threshold current SS as the arrangement shown in FIG. 1 so that, in consequence, the advantages associated with this can also be achieved.

Since there is no necessity to use a low-pass filter TP which can be activated and deactivated, the arrangement shown in FIG. 2 may, however, be designed such that it is simpler than the arrangement shown in FIG. 1.

It is clear, and requires no further explanation, that the arrangement shown in FIG. 2 can be modified in the same way as the arrangement shown in FIG. 1.

The arrangements which are shown in FIGS. 1 and 2 make it possible to determine reliably and correctly the respectively present level of the digital signal DS for which the signal state which represents the low level and/or the signal state which represents the high level are/is not known or are/is not known precisely, and/or which can change, and/or on which disturbances are superimposed.

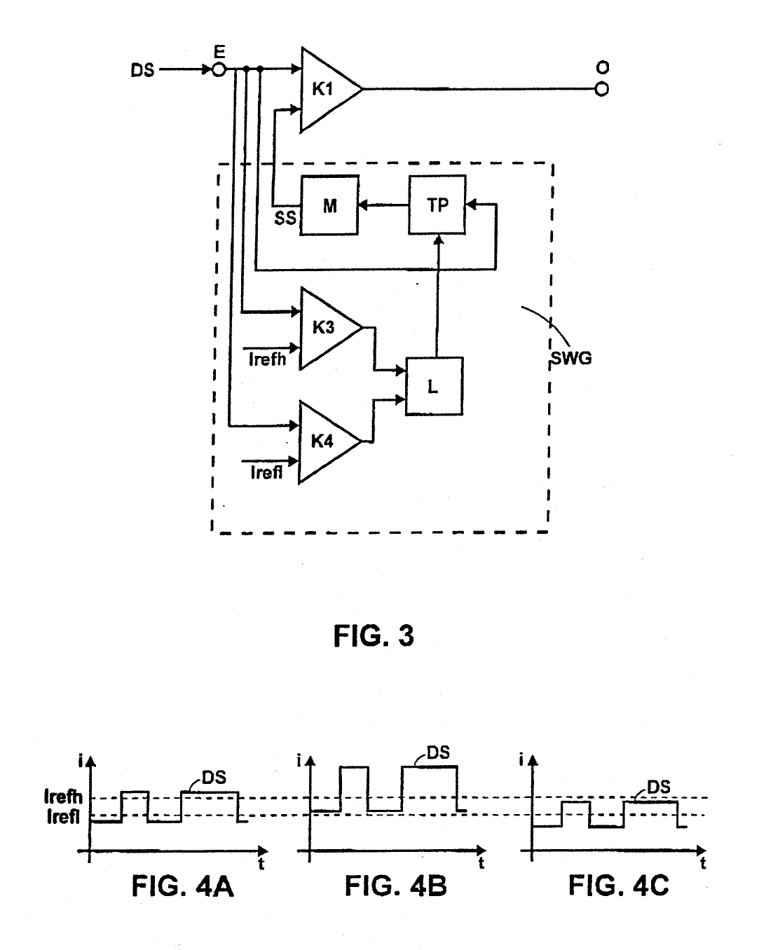

An arrangement will now be described with reference to FIGS. 3 to 5, by means of which the respectively present level of the digital signal DS can be determined even more reliably than is the case with the arrangements shown in FIGS. 1 and 2.

The majority of the arrangement which is shown in FIG. 3 corresponds to the arrangement which is shown in FIG. 1. Components which are annotated with the same reference symbols are identical or mutually corresponding components.

The arrangement which is shown in FIG. 3 differs from the arrangement which is shown in FIG. 1 in that a third comparator K3, a fourth comparator K4 and a logic device L are provided instead of the second comparator K2, with,

the third comparator K3 comparing the digital signal DS with a reference current Irefh,

the fourth comparator K4 comparing the digital signal DS with a reference current Irefl, and

the logic device L actuating (activating and deactivating) the low-pass filter TP as a function of the state and of the waveform of the signals emitted from the comparators K3 and K4.

It should be mentioned at this point that the logic device L can also actuate the switching device S, which is used in the arrangement shown in FIG. 2, instead of the low-pass filter TP.

The reference currents Irefh and Irefl which are used by the comparators K3 and K4 are defined such that, in all circumstances, that is to say with all waveforms which the digital signal DS may have, at least the reference current Irefh or the reference current Irefl is located between the current which represents the high level of the digital signal DS and the current which represents the low level of the digital signal DS, with it being possible either for the reference current Irefh to be greater than the current which represents the high level in the digital signal DS or for the reference current Irefl to be less than the current which represents the low level in the digital signal DS, and with it not being possible for the reference current Irefh to be less than the current which represents the low level in the digital signal DS or the reference current Irefl to be greater than the current which represents the high level in the digital signal DS.

One possible definition of the reference currents Irefh and Irefl is shown, by way of example, in FIGS. 4A, 4B, and 4C.

It is also possible to supply the arrangement with only a single reference current (for example the reference current Iref as shown in FIG. 1 and FIG. 2), and for the reference currents Irefh and Irefl to be calculated from this single reference current, or to be determined in some other way.

The comparator K3 emits a signal HC to the logic device L, which has the value 1 in the example under consideration, when DS is greater than Irefh, and has the value 0 when DS is less than Irefh.

The comparator K4 emits a signal LC to the logic device L, which has the value 1 in the example under consideration, when DS is greater than Irefl, and which has the value 0 when DS is less than Irefl.

The logic device L assumes that the digital signal DS is at the low level and activates the low-pass filter TP,

when LC is equal to 0 or becomes equal to 0, or

when HC changes from 1 to 0.

The logic device L assumes that the digital signal DS is at the high level and deactivate s the low-pass filter TP,

when H is equal to 1 or becomes 1, or

when LC changes from 0 to 1.

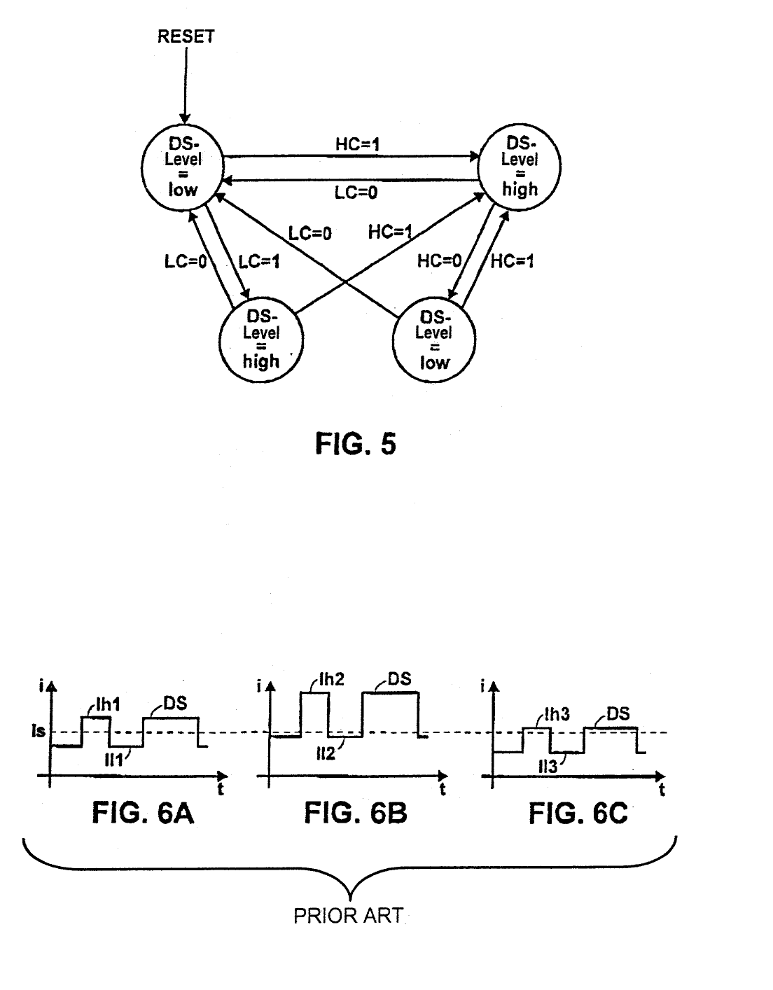

These relationships are illustrated in the state diagram shown in FIG. 5.

The process for determining the respectively present level of the digital signal operates even more reliably if the comparators K3 and K4 have a hysteresis function, that is to say when the current which DS must exceed for the output signal from the respective comparator to change from 0 to 1 is greater than the current which DS must fall below for the output signal from the respective comparator to change from 1 to 0. The arrangement is then even less sensitive to disturbances superimposed on the digital signal than is already the case anyway.

Furthermore, this also applies to the comparators K2 which are used in the arrangements shown in FIGS. 1 and 2.

Independently of this, the arrangements described above can also be modified such that the multiplier M is not arranged downstream from the low-pass filter TP but upstream of the low-pass filter, or is arranged upstream of the switching device S, or is integrated in the switching device S.

The low-pass filter TP is then supplied with a current, at least specific parts of which represent the threshold current SS. The low-pass filter TP subjects the signal which is supplied to it, or those parts thereof which represent the threshold current SS, to low-pass filtering and emits the threshold current SS as a result. The low-pass filter TP and/or the switching device S are/is actuated in this case as has been described above with reference to FIGS. 1 to 5.

The described arrangements and methods make it possible, irrespective of the details of the practical implementation for the level of a digital signal to be identified reliably and without errors, even when the signal state which represents the low level and/or the signal state which represents the high level are/is not known or not known accurately, and/or can change.

We claim:

1. A device for determining a respectively present level of a digital signal, comprising:
a comparison device configured to compare the digital signal with a threshold value defined between a state representing a low level of the digital signal and a state representing a high level of the digital signal; and
a threshold value determining device connected to said comparison device for defining the threshold value to be used by said comparison device and thereby taking into account a waveform of the digital signal.

2. The device according to claim 1, wherein said threshold value determining device is configured to determine at least one of the state representing the low level of the digital signal and the state representing the high level of the digital signal, and to define the threshold value taking account of a result of the determination process.

3. The device according to claim 1, wherein a determination of the state representing the low level of the digital signal and/or of the state representing the high level of the digital signal comprises a determination of one of a current and a voltage which the digital signal has on average when it is represented by this low level or high level.

4. The device according to claim 1, wherein a part of said threshold value determining device that determines the state representing the low level of the digital signal and/or the state representing the high level of the digital signal is a low-pass filter

5. The device according to claim 1, wherein a part of said threshold value determining device that determines the state representing the low level of the digital signal is deactivated when and for as long as the digital signal is in the state representing the high level.

6. The device according to claim 1, wherein a part of said threshold value determining device that determines the state representing the high level of the digital signal is deactivated when and for as long as the digital signal is in the state representing the low level.

7. The device according to claim 1, wherein a part of said threshold value determining device that determines one of the low level and the high level of the digital signal is activated and deactivated while a respectively other level of the digital signal is present in dependence on a result of a comparison of the digital signal with a reference current or a reference voltage.

8. The device according to claim 1, wherein a part of said threshold value determining device that determines one of the low level and the high level of the digital signal is activated and deactivated while a respectively other level of the digital signal is present in dependence on a result of multiple comparisons of the digital signal with a number of reference currents or reference voltages.

9. The device according to claim 7, wherein the activation and deactivation is carried out as a function of a waveform of the comparison result.

10. The device according to claim 1, wherein said threshold value determining device has a part for determining the state representing the low level of the digital signal and, preceding said part in a signal flow direction, a device for ensuring that said part is continuously supplied with a signal in the state representing the low level.

11. The device according to claim 10, wherein said device connected upstream of said part is configured to:
supply the digital signal or a signal which corresponds to this signal to that part of the threshold value determining device which determines the state representing the low level of the digital signal, when and for as long as the digital signal is in the state representing the low level; and
convert the digital signal to a signal which is in a state which represents a low level, and supplies this signal to that part of the threshold value determining device which determines the state representing the low level of the digital signal, when and for as long as the digital signal is in the state representing the high level.

12. The device according to claim 10, wherein said device connected upstream of said part is controlled as a function of a result of one or more comparisons of the digital signal with one or more reference currents or reference voltages.

13. The device according to claim 1, wherein said threshold value determining device has a part for determining the state representing the high level of the digital signal and, preceding said part in a signal flow direction, a device for ensuring that said part is continuously supplied with a signal in the state representing the high level.

14. The device according to claim 13, wherein said device connected upstream of said part is configured to:
supply the digital signal or a signal corresponding to the signal to that part of the threshold value determining device which determines the state representing the high level of the digital signal, when and for as long as the digital signal is in the state representing the high level; and
convert the digital signal to a signal that is in a state which represents a high level, and supply this signal to that part of the threshold value determining device which determines the state representing the high level of the digital signal, when and for as long as the digital signal is in the state representing the low level.

15. The device according to claim 13, wherein said device connected upstream of said part is controlled as a function of a result of one or more comparisons of the digital signal with one or more reference currents or reference voltages.

16. The device according to claim 15, wherein the upstream device is controlled as a function of a waveform of the comparison results.

17. The device according to claim 1, wherein the threshold value is determined by multiplying that state representing the low level of the digital signal or that state representing the high level of the digital signal by a specific factor.

18. The device according to claim 1, wherein said threshold value determining device contains a device that converts the voltage which represents the high level or the current which represents the high level, and/or the voltage which represents the low level or the current which represents the low level to a voltage which is greater or less by a specific factor, or to a current which is greater or less by a specific factor.

19. The device according to claim 18, wherein the factor is chosen such that at least parts of the voltage which is emitted from the device or at least parts of the current which is emitted from the device represent the threshold value for a digital signal on which no disturbances are superimposed.

20. The device according to claim 18, wherein the factor is varied as a function of the result of a comparison of the digital signal with a reference current or a reference voltage.

21. The device according to claim 18, wherein the factor is varied as a function of results of comparisons of the digital signal with a number of reference currents or reference voltages.

22. The device according to claim 21, wherein the factor is varied as a function of the waveform of the comparison results.

23. The device according to claim 18, wherein said device is followed, in a signal flow direction, by an averaging device configured to form a mean value of the voltage supplied to it or of the current supplied thereto.

24. The device according to claim 23, wherein said averaging device is a low-pass filter.

25. The device according to claim 23, wherein an output signal from said averaging device is used as the threshold value.

26. The device according to claim 23, wherein said averaging device is deactivated when and for as long as the digital signal is in a state representing the high level.

27. The device according to claim 23, wherein said averaging device is deactivated when and for as long as the digital signal is in a state representing the low level.

28. The device according to claim 23, wherein said averaging device is selectively activated and deactivated when and for as long as the digital signal is in one of a state representing the low level or in a state representing the high level and the activation and deactivation of the averaging device is carried out as a function of the result of the comparison of the digital signal with a reference current or a reference voltage.

29. The device according to claim 23, wherein said averaging device is selectively activated and deactivated when and for as long as the digital signal is in one of a state representing the low level or in a state representing the high level and the activation and deactivation of the averaging device is carried out as a function of the results of the comparisons of the digital signal with a number of reference currents or reference voltages.

30. The device according to claim 29, wherein the activation and deactivation of said averaging device are carried out as a function of a waveform of the comparison results.

31. A method for determining the respectively present level of a digital signal, which comprises:
comparing the digital signal with a threshold value which defined between a state representing a low level of the digital signal and a state representing a high level of the digital signal; and
matching the threshold value to prevailing conditions and defining the threshold value taking account of a waveform of the digital signal.

32. The method according to claim 31, wherein the state representing the low level of the digital signal and/or the state representing the high level of the digital signal is determined, and the threshold value is defined taking into account the result of the determining step.

33. The method according to claim 31, wherein the step of determining the state representing the low level of the digital signal and/or of the state representing the high level of the digital signal comprises determining a current or of a voltage which the digital signal has on average when it is represented by the low level or high level.

34. The method according to claim 31, wherein the determination of the state representing the low level of the digital signal and/or of the state representing the high level of the digital signal is carried out with a low-pass filter.

35. The method according to claim 31, which comprises deactivating that part of the device that determines the state representing the low level of the digital signal when and for as long as the digital signal is in the state representing the high level.

36. The method according to claim 31, which comprises deactivating that part of the device that determines the state representing the high level of the digital signal when and for as long as the digital signal is in the state representing the low level.

37. The method according to claim 31, which comprises activating and deactivating that part of the device that determines the state representing the low level of the digital signal or the state representing the high level of the digital signal as a function of a result of the comparison of the digital signal with a reference current or a reference voltage.

38. The method according to claim 31, which comprises activating and deactivating that part of the device that determines the state representing the low level of the digital signal or the state representing the high level of the digital signal as a function of results of the comparisons of the digital signal with a number of reference currents or reference voltages.

39. The method according to claim 38, wherein the activation and deactivation of that part of the device which determines the state representing the low level of the digital signal or the state representing the high level of the digital signal are carried out as a function of the waveform of the comparison results.

40. The method according to claim 31, wherein that part of the device which determines the state representing the low level of the digital signal is preceded by a device which ensures that that part of the device which determines the state representing the low level of the digital signal is continuously supplied with a signal which is in the state representing the low level.

41. The method according to claim 40, wherein the upstream device is driven to:
supply the digital signal or a signal which corresponds to this signal to that part of the arrangement which determines the state representing the low level of the digital signal, when and for as long as the digital signal is in the state representing the low level, and
convert the digital signal to a signal which is in a state which represents a low level, and supplies this signal to that part of the arrangement which determines the state representing the low level of the digital signal, when and for as long as the digital signal is in the state representing the high level.

42. The method according to claim 40, wherein the upstream device is controlled as a function of a result of a comparison of the digital signal with one or more reference currents or one or more reference voltages.

43. The method according to claim 31, wherein that part of the arrangement which determines the state representing the high level of the digital signal is preceded by a device which ensures that that part of the arrangement which determines the state representing the high level of the digital signal is continuously supplied with a signal which is in the state representing the high level.

44. The method according to claim 43, wherein the upstream device is driven to:
supply the digital signal or a signal which corresponds to this signal to that part of the arrangement which determines the state representing the high level of the digital signal,
when and for as long as the digital signal is in the state representing the high level, and
convert the digital signal to a signal which is in a state which represents a high level, and supplies this signal to that part of the arrangement which determines the state representing the high level of the digital signal, when and for as long as the digital signal is in the state representing the low level.

45. The method according to claim 43, wherein the upstream device is controlled as a function of a result of a comparison of the digital signal with one or more reference currents or one or more reference voltages.

46. The method according to claim 45, wherein the upstream device is controlled as a function of the waveform of the comparison results.

47. The method according to claim 31, wherein the threshold value is determined by multiplying that state representing the low level of the digital signal or that state representing the high level of the digital signal by a specific factor.

48. The method according to claim 31, wherein the threshold value determining device contains a device which converts the voltage which represents the high level or the current which represents the high level, and/or the voltage which represents the low level or the current which represents the low level to a voltage which is greater or less by a specific factor, or to a current which is greater or less by a specific factor.

49. The method according to claim 48, wherein the factor is chosen such that at least parts of the voltage which is emitted from the device or at least parts of the current which is emitted from the device represent the threshold value for a digital signal on which no disturbances are superimposed.

50. The method according to claim 48, wherein the factor is varied as a function of the result of the comparison of the digital signal with a reference current or a reference voltage.

51. The method according to claim 48, wherein the factor is varied as a function of the results of the comparisons of the digital signal with a number of reference currents or reference voltages.

52. The method according to claim 51, wherein the factor is varied as a function of the waveform of the comparison results.

53. The method according to claim 48, wherein the device is followed by an averaging device which forms the mean value of the voltage supplied to it or of the current supplied to it.

54. The method according to claim 53, wherein the averaging device is a low-pass filter.

55. The method according to claim 53, which comprises using an output signal of the averaging device as the threshold value.

56. The method according to claim 53, which comprises deactivating the averaging device when and for as long as the digital signal is in a state representing the high level.

57. The method according to claim 53, which comprises deactivating the averaging device when and for as long as the digital signal is in a state representing the low level.

58. The method according to claim 53, which comprises selectively activating and deactivating the averaging device when and for as long as the digital signal is in one of a state representing the low level and a state representing the high level as a function of a result of a comparison of the digital signal with a reference current or a reference voltage.

59. The method according to claim 53, which comprises selectively activating and deactivating the averaging device when and for as long as the digital signal is in one of a state representing the low level and a state representing the high level as a function of results of the comparisons of the digital signal with a number of reference currents or reference voltages.

60. The method according to claim 59, which comprises activating and deactivating the averaging device as a function of the waveform of the comparison results.
